(19) United States
(12) Patent Application Publication
(10) Pub. No.: US 2009/0205220 A1
(43) Pub. Date: Aug. 20, 2009

(54) Dryer and adapter having ducting system

(76) Inventors: Charles Robert Dewald, III, Morristown, TN (US); Thomas L. Cristello, Union, NJ (US)

Correspondence Address: Law Office of William Nixon, PO Box 7637, Falls Church, VA, 22040, US

(21) Appl. No.: 12/071,337

(22) Filed: Feb. 20, 2008

(51) Int. Cl. F26B 21/04

(52) U.S. Cl. 34/513; 34/131; 34/72

(57) ABSTRACT

An adapter to a dryer, or a new configuration to a dryer, allows articles, such as clothes, towels, sheets and the like to dry with reduced energy consumption. The adapted configuration draws air from outside the room or structure housing the dryer. The outside air is then used to dry the articles. The outside air can be heated within the dryer using the existing heater prior to entering the drum holding the articles. After the heated air removes moisture from the articles, the moist, hot air is expelled outside the room or structure through an outlet air duct. Thus, air within the room or structure is not used for the drying process and conditions such as temperature and pressure are not changed when the dryer is on.

### BACKGROUND OF THE INVENTION

The present invention relates to a dryer using heated air to dry items. More particularly, the present invention relates to a dryer using a ducting system to select air from outside a room or structure that enhances a drying process.

### DISCUSSION OF THE RELATED ART

Clothes dryers basically work in the same manner. The dryer sucks in air from the surrounding area. The dryer heats the air using an electric heating element, a gas burner and the like. The air passes into a tumbler housed within the dryer once it is heated. The hot air evaporates water from the clothes as they spin inside the tumbler. The dryer then forces the evaporated water out along with the hot air. Typically, a vent allows the air and moisture to exit the room.

As noted above, the dryer draws air from the surrounding area, such as a basement or laundry room. The dryer heats this air and blows it across wet clothes, towels, and the like. Typically, the blown air includes a high energy content that accelerates the evaporation process within the dryer. Thus, the articles being dried release large amounts of evaporated water, or water vapor, into the air stream flowing through the dryer and out the vent.

To complete the drying process, the wet air must be exchanged with fresh dry air to maintain a substantial affinity for water vapor. Thus, the dryer exhausts wet heated air into the vent. The dryer exhausts the heated air, preferably, outside the house or building. Failure to blow the heated air outside results in air within the house or building having a high temperature and high moisture content. Air having these characteristics would be unpleasant and harmful.

Even if the exhaust air blows outside, harmful effects occur on the house or building of the dryer. The dryer exhaust vent blows air outside at a rate of about 150 to 200 cubic feet per minute (CFM). The air blown outside places a negative pressure on the house. The negative pressure must be equalized. Thus, if about 150-200 CFM of air is blown outside the house, then an equal amount of air must be drawn in from the outside to replace the expelled air.

Depending on the time of year, the new air entering the house is heated or cooled by heating or climate control systems. This process results in extra energy costs to owners or users of the house. In a commercial laundry setting, these costs can be substantial. In some instances, a home may heat or cool an extra 4,000-12,000 Btus/hr. Thus, the dryer, when on, increases energy consumption, wastes resources and drives up costs.

### SUMMARY OF THE INVENTION

The disclosed embodiments of the present invention relate to a dryer adapter and apparatus that improves drying efficiency and reduces energy consumption. The adapter may be used with existing dryers or installed in new dryers. For example, the disclosed embodiments of the present invention may be retrofitted on existing dryers within a commercial laundry.

The disclosed embodiments include two vents going from the dryer to an outside, ambient, or stable, environment. Using these vents, the disclosed embodiments may eliminate the negative pressure placed on the building due to dryer use. Thus, dryers can achieve a “neutral pressure” situation for the building. Neutral pressure indicates the extra air is not drawn from outside the building into the building to replace the air expelled during the drying process. An extra 150-200 CFM of air does not need to be heated or cooled during use of the dryer. As a result, an additional 4,000-12,000 Btu/hr is saved. Energy costs are reduced and resources conserved by using the disclosed embodiments of the present invention.

In addition to lowering costs, the disclosed embodiments may allow a dryer to select between inside air or outside air based on the vapor pressure of the different air locations and what is best for the dryer. An adapter according to the disclosed embodiments exchanges air with the outside to keep the neutral pressure. A dryer, however, having the disclosed adapter may, in very rare instances, select the air nearer to the dryer, in the room, or even from another location within the building for exchange. In these instances, at least one sensor may be used to measure conditions that allow selection of where to exchange the air.

Vapor pressure dictates how much energy is needed to evaporate the water from the drying article. A certain amount of energy, such as about 1060 British Thermal Units (BTUs), is needed to evaporate 1 pound of air. Reducing the vapor pressure in that air would reduce the amount of energy needed to evaporate the pound of air. Vapor pressure may vary according to location and other conditions, but it can almost always be reduced. The disclosed embodiments of the present invention relates to reducing the vapor pressure in air resulting from drying.

According to the present invention, a dryer apparatus is disclosed. The dryer apparatus includes an inlet air duct having an inlet flow path. The inlet flow path includes air from outside a structure. The dryer apparatus also includes an outlet air duct having an outlet air flow path. The outlet aid flow path includes heated air flowing to outside the structure.

According to the present invention, an adapter for a dryer having an outlet air duct also is disclosed. The adapter includes an inlet air duct to attach to the dryer and to an aperture allowing access to an outside area. An inlet air flow path is created within the inlet air duct. The adapter also includes an intake ring to mount on the dryer and support the inlet air duct and to operatively guide the inlet air flow path into the dryer. The inlet air duct is separate from the outlet air duct.

According to the present invention, a method to enhance drying within a dryer located in a room or structure also is disclosed. The method includes drawing air from outside the room or structure to create an intake air flow path. The method also includes heating air from the intake air flow path to remove moisture from articles within the dryer. The method also includes expelling the heated air through an outlet air duct to outside the room or structure.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a dryer apparatus having two ducts according to the disclosed embodiments.

FIG. 2 illustrates an intake duct configuration according to the disclosed embodiments.

FIG. 3 illustrates a flowchart for a method to enhance drying according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

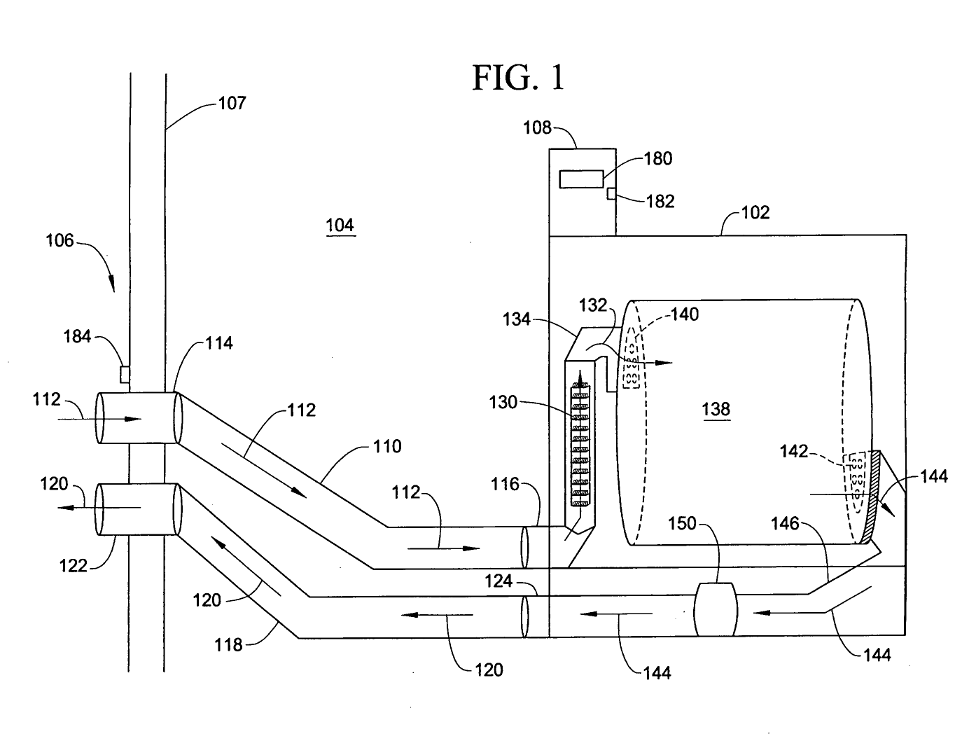

FIG. 1 depicts a dryer 102 having an intake duct 110 and an outlet duct 118 according to the disclosed embodiments. Dryer 102 may use forced, heated air to remove moisture and wetness from articles, such as clothes, towels, fabric, dishes, household items, and the like. Preferably, the articles are contained within a rotating drum housed in dryer 102. The forced air passes over the articles to remove moisture from them. Dryer 102 comprises the components of dryers known in the art, which are not disclosed in great detail here. Essentially, dryer 102 is any dryer that uses heated air to dry articles, such as clothes.

Dryer 102, however, differs from known dryers in several ways. For example, dryer 102 intakes air from outside of room 104. Room 104 includes the surrounding environment of dryer 102. Room 104 may be a small laundry room in a house, a basement of a house or building, or the space in a commercial laundry. Room 104 represents a closed or semi-closed space housing dryer 102. Room 104, however, is not a closed-off room in the sense that no doors, windows or other passages do not connect room 104 with other rooms or even the outside. If room 104 is within a house or building, then conditions in room 104 may effect conditions within the house or building, such as an increased temperature or change in vapor pressure.

Outdoors area 106 represents the area and air outside room 104. The air from outdoors area 106 provides an ambient condition for the exchange of air with dryer 102. In other words, the movement of air from and to outdoors area 106 will not impact the temperature or pressure of its air, unlike the air in room 104.

Outdoors area 106 and room 104 are separated by wall, or barrier, 107. Outdoors area 106 preferably is the “outdoors” in the sense the air is not enclosed within a space or regulated, such as the air in room 104. Alternatively, outdoors area 106 may be a larger environment having cooler air and a lower pressure than the air in room 104. Thus, intake air flow 112 represents the outside air coming into dryer 102 via intake duct 110.

Preferably, the air within air flow 112 is fresh, dry air from outdoors area 106. As the air cycles through dryer 102, the air absorbs moisture and wetness from the articles in drum 138. The air also is heated before entering drum 138 to facilitate the drying process in dryer 102. Dryer 102 expels the hot, moist air through outlet duct 118 as outlet air flow 120. Thus, air from room 104 is not needed or required in operating dryer 102. Although dryer 102 inevitably may take in some air from room 104, the majority of the air comes from outdoors area 106.

Preferably, ducts 110 and 118 are conventional ducts to help move air from one location to another. More preferably, ducts 110 and 118 are 4 inch ducts. Ducts 110 and 118, however, are not limited to this size. Other sizes also may be used without taking away from the performance of dryer 102. Further, intake duct 110 may differ in size than outlet duct 118, especially if outlet duct 118 is the duct originally connected to dryer 102.

As a result, the temperature and pressure of the air in room 104 remains relatively stable while dryer 102 is in use. Variances in room conditions may be eliminated so that utilities are not working to keep the temperature and pressure stable within room 104. Heaters or air conditioners within room 104 are not overworked to heat or cool new air to replace the air going outside through outlet duct 118. Extra energy and resources are not used to keep the temperature and pressure of the air in room 104 constant.

Intake duct 110 connects to wall 107 using adapter vent 114 and to dryer 102 using intake ring 116. Vent 114 may be configured to open when air is brought into intake duct 110. When intake duct 110 is not in use, then vent 114 is closed to prevent outside dirt, debris and the like from clogging intake duct 110 or getting into dryer 102.

Intake ring 116 may not be part of the original configuration of dryer 102. Thus, a hole or other aperture may have to be made to allow the outside air come into dryer 102. If so, then an adapter kit of the disclosed embodiments includes intake ring 116 to attach to dryer 102. Alternatively, intake ring 116 may be adjustable to fit within an existing hole or aperture to avoid modifications to dryer 102. In another embodiment, intake ring 116 or intake duct 110 may adjust or adapt for use with outlet ring 124.

Outlet duct 118 connects to wall 107 using vent 122 and to dryer 102 using outlet ring 124. Outlet duct 118 may operate as conventional ducts do with dryers to allow the heated air from dryer 102 to flow outside. Preferably, vent 122 is closed when dryer 102 is not in use.

Outlet duct 118 is located below intake duct 110 because the air flows out from dryer 102 under the drum and other components. Preferably, outlet duct 118 and outlet ring 124 are part of the existing configuration of dryer 102. Further, because hot air rises, outlet air flow 120 rises up to vent 122. In contrast, intake duct 110 brings air from outdoors area 106 into the section of dryer 102 that heats the air before applying it to the articles. Alternatively, ducts 110 and 118 may be located next to each other or anywhere else on dryer 102. Further, duct 110 may be located within duct 118, and vice versa.

Once intake air flow 112 brings air into dryer 102, it flows through heater 130. Heater 130 may act as a conventional heater for dryers, and already may be located in dryer 102 to heat air before it goes into drum 138. Thus, intake ring 116 connects with the passage flowing air through heater 130 when adapted to dryer 102. Heater 130 heats the air to raise its temperature and water absorption potential. Heater 130 expels heated air 132 into drum 138 of dryer 102. Heated air 132 flows through connector 134.

Drum 138 holds the clothes, towels, sheets and the like. Articles within drum 138 have heated air 132 flow over them to remove water. The heat from the air gives energy to the water within the articles so that the water molecules evaporate. Heated air 132 comes into drum 138 through holes 140. Holes 140 may include a screen or filter to remove debris, dirt and dust coming from outdoors area 106.

Articles within drum 138 are tumbled around so that the heated air flowing through holes 140 can access all surface areas. As the water evaporates within drum 138, the air becomes moist. Dryer 102 needs to remove the moist heated air from drum 138 as it gets saturated with water. In FIG. 1, moist air 144 flows out of drum 138 through holes 142. Holes 142 may be located opposite holes 140 on drum 138. The opposite locations induce an air flow path within drum 138. Holes 142 may act as a lint filter or other device used to remove debris, dust and the like from moist air 144.

Moist air 144 exits drum 138 into passage 146. Passage 146 may be the existing outlet flow passage for dryer 102. Fan 150 helps suck moist air 144 from drum 138. Moist air 144 moves through outlet ring 124 and onto outdoors area 106. Dryer 102 moves moist air 144 outside room 104 for the same reasons it sucks in air from outdoors area 106. If moist air 144 did not leave room 104, the vapor pressure and temperature would rise.

Thus, as disclosed by FIG. 1, dryer 102 of the present invention draws in air from outdoors area 106 and expels moist air to the same location. Air from within room 104 is not actively drawn into dryer 102. Thus, room 104 is not subject to fluctuations of its temperature or vapor pressure as dryer 102 runs. The use of outside air for dryer 102, therefore, may reduce costs associated with heating and cooling room 104, and save resources such as electricity and gas for performing these tasks.

Thus, FIG. 1 shows a configuration according to the disclosed embodiments that brings air to dryer 102 from outside and expels the heated air after drying outside. The disclosed embodiments may come as an adapter that is attached to existing components within dryer 102. For example, intake duct 110 may deliver air directly to heater 130. Outlet duct 118 may be the pre-existing duct of dryer 102. Thus, the adapter according to the present invention includes intake duct 110, vent 114 and intake ring 116. Holes are made in wall 107 and the back of dryer 102 to mount vent 114 and intake ring 116, respectively. Tools may be provided with the adapter to make the holes.

The disclosed embodiments also may apply to new dryers where the two duct configuration is built in dryer 102. In those instances, dryer 102 is not refitted with any parts and is assembled as disclosed by FIG. 1. Further, a sensor control system may be installed on dryer 102 to determine whether to draw air from outdoors area 106 or, in the alternative, from room 104.

Any sensor would be optional on a dryer apparatus according to the disclosed embodiments. Dryers are clearly capable of using the disclosed embodiments without the use of sensors. Referring to FIG. 1, processor 180 receives data from sensors 182 and 184 to determine where to draw air. Sensor 182 may determine the temperature or pressure of air within room 104. Sensor 182 may take a simple reading when queried by processor 180. Sensor 184 may perform the same action of air outside room 104. Sensor 184 may communicate its readings over a wireless connection to processor 180. Processor 180 then compares the readings to determine from which location to draw in air.

In very rare instances, air within room 104 might be better suited for heating and drying articles within dryers 102. Air in outdoors area 106 may humid or too cold to make any sense to use it. For example, heater 130 may be required to work at such a level that no tradeoff in saving energy is realized by using the outside air. For whatever the reason, processor 180 may choose not to draw air via intake duct 110. In those instances, intake ring may close to prevent air flow from intake duct 110.

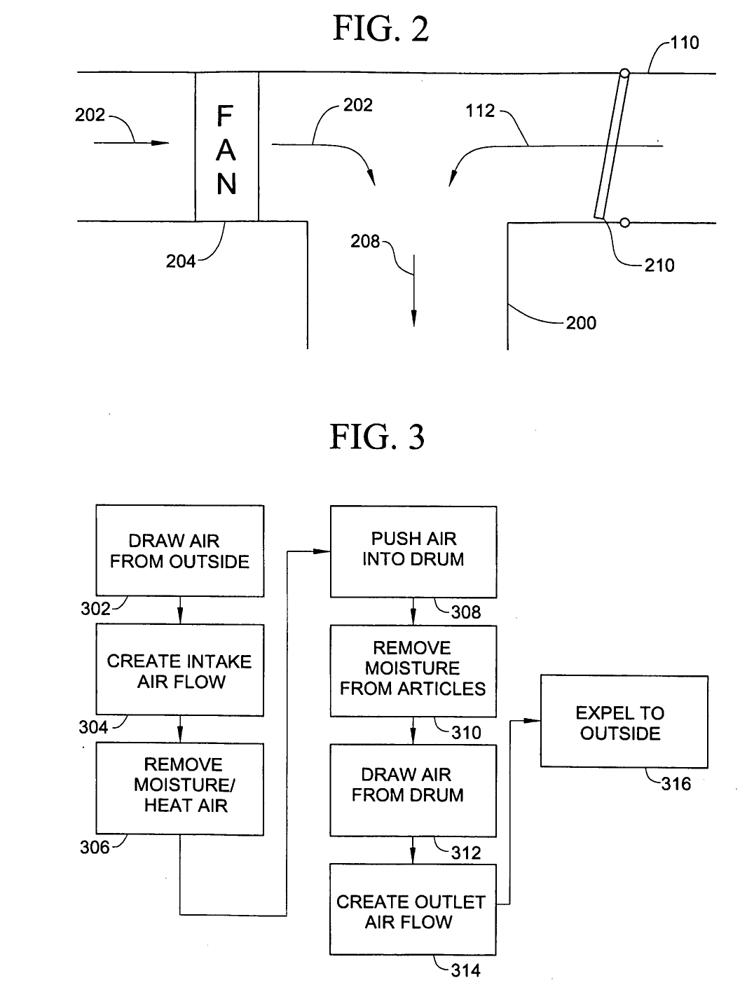

For example, referring to FIG. 2, a t-shaped duct 200 may combine air flows from outdoors area 106 with one from room 104 to form air flow 208 into dryer 102. Duct 200 connects with duct 110 disclosed above. Duct 110 provides intake air flow 112 from outdoors area 106.

Duct 200 also sucks in air flow 202 from an area close to dryer 102. Air is drawn from room 104 to create air flow 202. Unlike intake air flow 112, air flow 202 may not come from an ambient environment. Further, air flow 202 may be sucked into duct 200 by fan 204. When fan 204 is off, no air is received from room 104, and air flow 208 includes intake air flow 112. When fan 204 is on, then intake air flow 112 may be stopped from entering duct 200 by vent door 210. The disclosed embodiments may automatically close vent door 210 whenever fan 204 is bring air into duct 200. Alternatively, vent door 210 may remain open, or not even be included with the disclosed embodiments, so that intake air flow 112 is combined with air flow 202. Fan 204 may receive a command from a sensor to activate and draw air from room 104.

Referring back to FIG. 1, processor 180 may be set by a user to bypass drawing air from outdoors area 106 and to use air within room 104 by turning on fan 204. In those instances, sensors 182 and 184 may be turned off. Moreover, the location of the air drawn into dryer 102 may be changed during drying operations if processor 180 determines conditions are better in one location than the other after initially choosing a location. For example, processor 180 determines the air in room 104 is better suited for drying. Processor 180 may send a command to close vent door 210. Thus, air flow through intake duct 110 is prevented.

Processor 180 then may take request readings from sensors 182 and 184 periodically, such as every 30 seconds. After about ten minutes, processor 180 receives readings showing the air from outdoors area 106 is now better, or that the air within room 104 is becoming too moist or hot. Intake duct 110 is opened to allow air flow from outdoors area 106 to heater 130. Of course, the time between readings from the sensors may vary. Further, air flow 202 may not necessarily only come from room 104, but from any area or location. For example, air flow 202 may come from another outside location. The disclosed embodiments, therefore, may mix air flows from different locations after reading taken by sensors are considered.

As disclosed above, dryer 102 may be an existing dryer fitted with a kit or other assembly to configure dryer 102 into a two duct arrangement. In other words, dryer 102 is retrofitted with parts to create intake duct 110 that flows to heater 130. A kit, for example, according to the disclosed embodiments may include intake duct 110, intake ring 116 that is attached to dryer 102. A hole, or aperture, should be made in dryer 102 to support intake ring 116. Intake ring 116, or an attachment, should guide intake air flow 112 to heater 130 in dryer 102. Heater 130 should already be located in dryer 102.

FIG. 3 depicts a flowchart of a method to enhance drying according to the disclosed embodiments. The method disclosed by the flowchart may be implemented with an adapter fitted to an existing dryer or incorporated into a dryer. The steps disclosed below may be incorporated into program executable by a processor, wherein the processor retrieves the program from a memory, such as processor 180. Alternatively, the steps may be executed manually or with a combination of manual and software implementations.

Step 302 executes by drawing, or sucking, air from outside, or from an environment having ambient conditions. For example, referring to FIG. 1, dryer 102 draws air from outdoors area 106. Step 304 executes by creating intake air flow 112 within duct 110 using the air from outside. Thus, an air flow is created using outside air.

Step 306 executes by removing moisture from the air or heating the air after it comes through duct 110. This step may be optional in the sense that removing the moisture by use of a desiccant or other means is not needed to implement the disclosed embodiments. Preferably, the air is heated after it comes into dryer 102, though it could be pushed right into drum 138. Step 308 executes by pushing the air into drum 138, preferably through heater 130. Step 310 executes by removing moisture from articles within drum 138 so as to dry them.

Step 312 executes by drawing the heated air from drum 138. Step 314 executes by creating an outlet air flow, such as outlet air flow 120. Dryer 102 uses fan 150 to suck the air from drum 138. Step 316 executes by expelling the air to outside and back to the ambient condition environment disclosed above. Thus, the intake and outlet air flows are kept separate. The hot, moist air from drum 138 does not get in the way of the air being taken from the outside. Further, air within room 104 is not disturbed or its conditions changed as a result of drying.

The disclosed embodiments of the present invention are applicable to dryers in a household or laundry setting, where air is drawn from and returned to the outside environment. The present invention, however, is not limited to these dryers and may be applicable to any situation where an article needs to be dried using forced air. The air is heated and the moisture removed as shown.

It will be apparent to those skilled in the art that various modifications and variations can be made in the disclosed embodiments of the present invention without departing from the spirit or scope of the invention. Thus, it is intended that the present invention covers the modifications and variations of the embodiments disclosed above provided that they come within the scope of any claims and their equivalents.

What is claimed is:

1. A dryer apparatus comprising:
an inlet air duct having an inlet air flow path, wherein the inlet air flow path includes air from outside a structure; and
an outlet air duct having an outlet air flow path, wherein the outlet air flow path includes heated air flowing to outside the structure.

2. The dryer of claim 1, further comprising a sensor to initiate the inlet air flow path through the inlet air duct.

3. The dryer of claim 1, further comprising a heater to receive the inlet air flow path.

4. The dryer of claim 1, wherein the heater generates the heated air.

5. The dryer of claim 1, further comprising a motor configured in the outlet air flow path.

6. The dryer of claim 5, wherein the motor draws the heated air and pushes the heated air to outside the structure.

7. An adapter for a dryer having an outlet air duct, the adapter comprising:
an inlet air duct to attach to the dryer and to an aperture allowing access to an outside area, wherein an inlet air flow path is created within the inlet air duct; and
an intake ring to mount on the dryer and support the inlet air duct and to operatively guide the inlet air flow path into the dryer;
wherein the inlet air duct is separate from the outlet air duct.

8. The adapter of claim 7, wherein the outlet air duct expels heated air from the dryer to the outside area.

9. The adapter of claim 7, further comprising a processor to open the intake air duct.

10. The adapter of claim 9, further comprising a sensor to communicate a reading to the processor, wherein the reading includes a temperature or a pressure determination.

11. A method to enhance drying within a dryer located in a room or structure, the method comprising:
drawing air from outside the room or structure to create an intake air flow path;
heating air from the intake air flow path to remove moisture from at least one article within the dryer; and
expelling the heated air through an outlet air duct to outside the room or structure.

12. The method of claim 11, wherein the drawing step includes drawing the air into an intake air duct that encloses the intake air flow path.

13. The method of claim 11, further comprising drawing the air from a drum.

14. The method of claim 12, wherein said air includes heated air.

15. The method of claim 11, further comprising heating the air prior to entering the drum.

16. The method of claim 11, further comprising removing moisture from the air in the intake air flow path.

17. An apparatus comprising:
means for drawing air from outside a room or structure to create an intake air flow path;
means for heating air from the intake air flow path to remove moisture from at least one article within the dryer; and
means for expelling the heated air through an outlet air duct to outside the room or structure.

18. The apparatus of claim 17, further comprising means for drawing the air from a housing holding the at least one article.

19. The apparatus of claim 17, further comprising means for removing moisture from the air in the intake air flow path.
